(19) United States
(12) Patent Application Publication
(10) Pub. No.: US 2023/0154288 A1
(43) Pub. Date: May 18, 2023

(54) SYSTEM FOR MOBILE SPORTS BETTING

(71) Applicants: Tom Mangan, Philadelphia, PA (US); Alex Cullingford, Philadelphia, PA (US)

(72) Inventors: Tom Mangan, Philadelphia, PA (US); Alex Cullingford, Philadelphia, PA (US)

(21) Appl. No.: 17/527,021

(22) Filed: Nov. 15, 2021

(51) Int. Cl. G07F 17/32; G06Q 20/10; G06Q 50/34

(52) U.S. Cl. CPC G07F 17/3288; G07F 17/3237; G06Q 20/102; G06Q 20/108; G06Q 50/34

(57) ABSTRACT

A sports betting system is disclosed, comprising a sportsbook database in operable communication with a user interface module. The sportsbook database stores sports betting information to be provided on the display of a user device. A financial database is in operable communication with a financial institution and user account thereof. The financial database stores a plurality of funds to be accessed while the user places a sports bet. A financial monitoring engine monitors a plurality of transactions associated with the user account, wherein the financial monitoring engine rounds up each transaction until a threshold value is reached. A fund transfer engine transfers the threshold value to the application system to permit the user to utilize the threshold value to place the sports bet.

### CROSS-REFERENCE TO RELATED APPLICATIONS

The present application claims priority to U.S. Provisional Application No. 63/078,683 filed Sep. 15, 2020, titled “SYSTEM FOR MOBILE SPORTS BETTING,” which is hereby incorporated by reference in its entirety.

### TECHNICAL FIELD

The embodiments generally relate to computerized systems for sports betting.

### BACKGROUND

Sports betting is a popular activity that people engage in at casinos, at sportsbooks, and at home. Both casual and die-hard sports fans enjoy sports betting where they place wagers on any of a wide variety of sporting events, and thus increasing the person's interest and enjoyment of the particular sporting event they are betting on. Bets may be placed on various occurrences for any particular sporting event including the outcome on the game or competition, the outcome at checkpoints throughout the game (e.g. halftime, after a period, or otherwise), individual player or participant performance, coin toss results, and numerous others.

Traditional sportsbooks are generally geographically confined to one or more particular physical locations. To increase their popularity and profitability, some sportsbooks are available or otherwise operate virtually online and may thus be accessed by anyone of legal gambling age with connectivity to the online betting system, where not prohibited. These computerized betting systems often allow users to research historical outcomes and trends of a team or event and the participants thereof, to shop for wagers which are enticing, as well as to select and execute one or more bets corresponding to the sporting event. Funding for the bet is frequently provided by or through a linked financial account or credits stored on or with the betting system which the user may access.

While online betting can be a fun pastime or activity for casual entertainment, it is well known that certain personality types may become addicted to gambling. Even occasional bettors can become carried away with betting, especially considering the ease with which online systems facilitate digital money movement, as opposed to holding physical money in hand and handing it over to a cashier to place a bet. As such, systems and methods that promote responsible betting are highly desirable. In particular, features that allow people to set betting limits for themselves, wager only according to preplanned budgets, and otherwise allow for and promote money management and responsibility for their users would be highly beneficial for bettors in particular and society in general.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to sports betting systems and methods, comprising at least one sportsbook database in operable communication with a user interface module. The sportsbook database stores sports betting information to be provided on the display of a user device. A financial database is in operable communication with at least one financial institution and user account(s) thereof. The financial database stores a plurality of funds to be accessed while the user is engaged in placing sports bets. A financial monitoring engine monitors a plurality of transactions associated with the user account, wherein the financial monitoring engine is operable to round up some or each transaction until a threshold value is reached (i.e. it operates as a mathematical step function). A fund transfer engine is operable to transfer the threshold value to the application system to permit the user to utilize the threshold value to place the sports bet.

The system allows the user to selectively transfer funds rounded up from financial transactions to the sports betting platform. In such, the user is utilizing known money-saving and investment strategies to responsibly fund sports betting activities while minimizing or eliminating detrimental potential outcomes such as spending too much.

In some embodiments, the system itself does not have any bet placing functionality. Rather, the system can link to or otherwise pass users through to third-party systems such as sportsbook websites. As such, they may place bets with the sportsbook in a cashier or other section of the sportsbook's website. In various embodiments portions of the sportsbook's website may be displayed through the system application's browser.

In some embodiments the system's rounded up amounts are placed into a bank account with the system that has a virtual debit card linked to the account. The user can then use the virtual debit card to make deposits on sports betting platform(s) such as sportsbook operator websites that are linked through the system. Users can also view their bank account number and routing number in order to enter a cashier section of a virtual or digital sportsbook and then pay via funds transfer through one or more mechanisms, e.g. through the automated clearing house (ACH).

In one aspect, a user database stores user preferences, user sports betting history, and at least one preferred threshold value associated with the user.

In one aspect, a financial database stores financial information associated with the user.

In one aspect, the sportsbook database stores a plurality of information corresponding to a plurality of sporting events.

In one aspect, the sportsbook database stores a plurality of information related to one or more participants of a sporting event.

In one aspect, the user selects a threshold value to initiate a fund transfer via the fund transfer engine.

In one aspect, a search engine permits the user to search for at least one of the following: a sporting event, a participant of the sporting event, and a wager type.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a block diagram of the payment processing system, according to some embodiments;

FIG. 4A illustrates a home user interface screen, according to some embodiments;

FIG. 4B illustrates a home user interface screen, according to some embodiments

FIG. 5A illustrates an account signup user interface screen, according to some embodiments;

FIG. 5B illustrates an account signup user interface screen, according to some embodiments

FIG. 6A illustrates a bank searching user interface screen, according to some embodiments;

FIG. 6B illustrates a bank searching user interface screen, according to some embodiments

FIG. 7A illustrates an account financial management user interface screen, according to some embodiments;

FIG. 7B illustrates an account financial management user interface screen, according to some embodiments

FIG. 8A illustrates a gaming sites election user interface screen, according to some embodiments;

FIG. 8B illustrates a gaming sites election user interface screen, according to some embodiments

FIG. 9A illustrates a payment linking user interface screen, according to some embodiments;

FIG. 9B illustrates a payment linking user interface screen, according to some embodiments

FIG. 10A illustrates an odds display user interface screen, according to some embodiments;

FIG. 10B illustrates an odds display user interface screen, according to some embodiments;

FIG. 11A illustrates an options selection user interface screen, according to some embodiments;

FIG. 11B illustrates an options selection user interface screen, according to some embodiments;

FIG. 12 illustrates a user sign up user interface screen, according to some embodiments;

FIG. 13 illustrates an account creation user interface screen, according to some embodiments;

FIG. 14 illustrates a security and login options user interface screen, according to some embodiments;

FIG. 15 illustrates a confirm option and PIN user interface screen, according to some embodiments;

FIG. 16 illustrates an agreements user interface screen, according to some embodiments;

FIG. 17 illustrates an email verification user interface screen, according to some embodiments;

FIG. 18 illustrates an email user interface screen, according to some embodiments;

FIG. 19 illustrates an account personal information user interface screen, according to some embodiments;

FIG. 20 illustrates an account personal information submission user interface screen, according to some embodiments;

FIG. 21 illustrates an account personal information confirmation user interface screen, according to some embodiments;

FIG. 22 illustrates an account linking user interface screen, according to some embodiments;

FIG. 23 illustrates an account sign in user interface screen, according to some embodiments;

FIG. 24 illustrates an account verification requirement user interface screen, according to some embodiments;

FIG. 25 illustrates an account code entry interface screen, according to some embodiments;

FIG. 26 illustrates an account selection user interface screen, according to some embodiments;

FIG. 27 illustrates an account sign in user interface screen, according to some embodiments;

FIG. 28 illustrates an account information confirmation interface screen, according to some embodiments;

FIG. 29 illustrates an account terms and conditions user interface screen, according to some embodiments;

FIG. 30 illustrates an account link user interface screen, according to some embodiments;

FIG. 31 illustrates an account configuration user interface screen, according to some embodiments;

FIG. 32 illustrates an account configuration user interface screen, according to some embodiments;

FIG. 33 illustrates an account configuration user interface screen, according to some embodiments;

FIG. 34 illustrates an account funding user interface screen, according to some embodiments;

FIG. 35 illustrates an existing account or creation user interface screen, according to some embodiments;

FIG. 36 illustrates an existing account or creation user interface screen, according to some embodiments;

FIG. 37 illustrates a menu user interface screen, according to some embodiments;

FIG. 38 illustrates a fund information user interface screen, according to some embodiments;

FIG. 39 illustrates a transactions user interface screen, according to some embodiments;

and

FIG. 40 illustrates a user info user interface screen, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments described herein relate to a system for mobile sports betting having a payment processing engine which monitors financial transactions and automatically transmits funds to the application system. The mobile sports betting system stores funds as in a bank account that is associated with the user account within the system which may be accessed and utilized to initiate and execute a sports bet. The financial monitoring engine may round up transactions to the nearest whole dollar amount, or other denomination, and transmit the amount of funds to the application system for future bets.

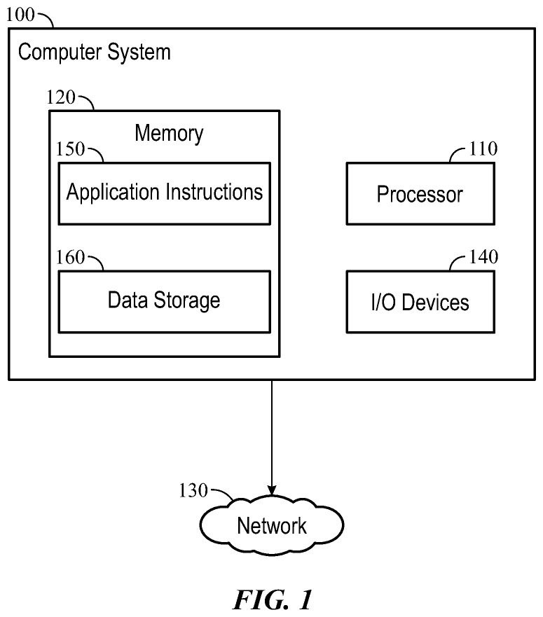

FIG. 1 illustrates an exemplary network infrastructure of the system. A computer system 100 may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

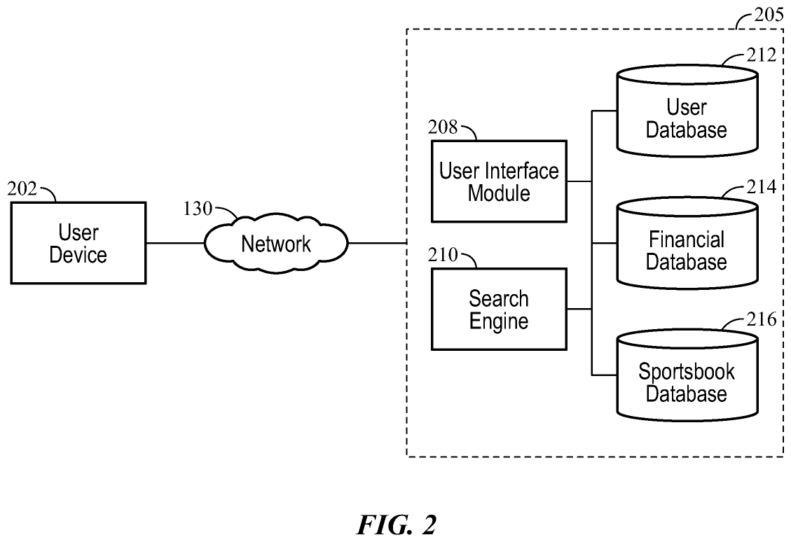

FIG. 2 illustrates a block diagram of the application system 205 which is utilized for receiving funds for betting and is utilized to access the various functionalities of the system described herein. A user device 202 is in operable communication with the application system 205 via network 130 to permit a user to access the application system in a remote location and provide sports betting functionalities on the user device 202. A user interface module 208 is operable to provide a plurality of interfaces including a sports betting interface, financial interface, and various information interfaces on the user device 202. For example, the user interface module 208 may display a plurality of sports betting opportunities which are currently available to wager on or may display information related to the sporting event and its participants. A search engine 210 allows the user to search sporting events, wagers, participants of the sport event, sportsbooks, and the like. A user database 212 stores user information including user groups (fantasy sports leagues), user preferences (e.g., amount at which the financial monitoring system will round up the amount to a predetermined denomination), user betting history, and the like. A financial database 214 may store financial information for the user including credit amounts, financial institution information, and the like. The sportsbook database 216 stores information commonly associated with a plurality of sportsbooks which the application system 205 may interact with. The sportsbook database 216 may store information pertaining to wagering schemes available for a particular event or group of events, previous wagers each user has placed on an event, and the like.

In some embodiments, the user may utilize the system to place a wager on fantasy sports or daily fantasy systems.

In some embodiments, the system may allow the user to select from a plurality of sportsbooks which are available to interact with.

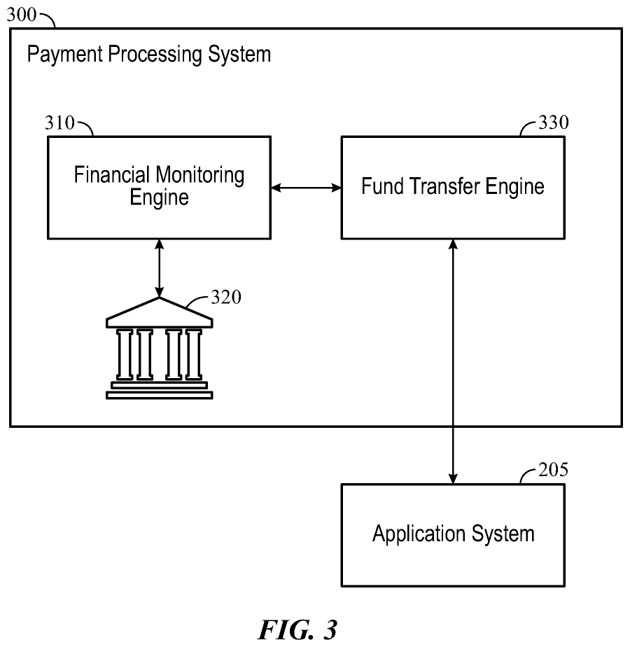

FIG. 3 illustrates a block diagram of the payment processing system 300 comprising a financial monitoring engine 310 which monitors financial transactions associated with a user account in a financial institution 320. The financial monitoring engine 310 may round up a difference between a transaction and a whole dollar amount, or other denomination (such as rounding up to the nearest $10 for each transaction) and maintain a total of the rounded amount. Once a threshold value is reached (e.g., each $1, $10, or $100 and the like) is reached, a fund transfer engine 330 will initiate a transfer for the threshold value amount which is transmitted to the application system 205 allowing the user to access the threshold amount for sports betting activities.

In one example, a user makes a plurality of purchases which are each rounded up to a dollar amount by the financial monitoring engine. Once enough purchases have been made such that the rounded amount is $10 (or other threshold value established by the user), the fund transfer engine will initiate a transfer from the user's bank account to the application system to permit the threshold value amount to be used for sports betting.

In some embodiments, the user may transfer a fixed percentage of their banking account deposits as an alternative, or in addition to the rounded amount described hereinabove.

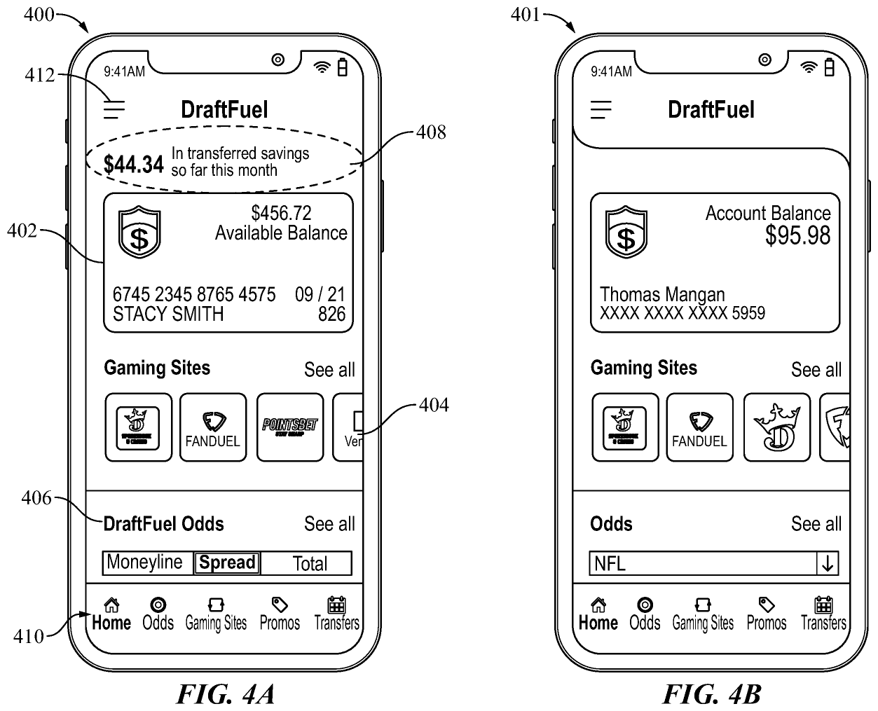

FIGS. 4A-4B illustrate a home user interface screen 400 and 401, respectively, according to some embodiments. As shown in the example embodiment, a virtual debit card 402 can include an available balance, a virtual debit card number, a virtual debit card expiration date, a virtual debit card security code, a virtual debit card account holder name, and/or additional related information as appropriate. A gaming sites area 404 can include a series of icons that may be scrollable and selectable. Users can also select a see all button to view a full listing of gaming sites, for instance in a grid, list, table, or other format. An odds area 406 can include information about odds for games that can be bet on by users, including money line, spread, total, or others. Users can also select a see all button to view a full listing of odds, for instance in a grid, list, table, or other format. A monthly transfer amount area 408 can include information about how much money has been transferred into the account over a given period (e.g. monthly, weekly, daily, or others). Navigation buttons 410 include a home button, an odds button, a gaming sites button, a promos button, a transfers button, or others in other embodiments. A selectable menu button 412 can display a menu in various embodiments.

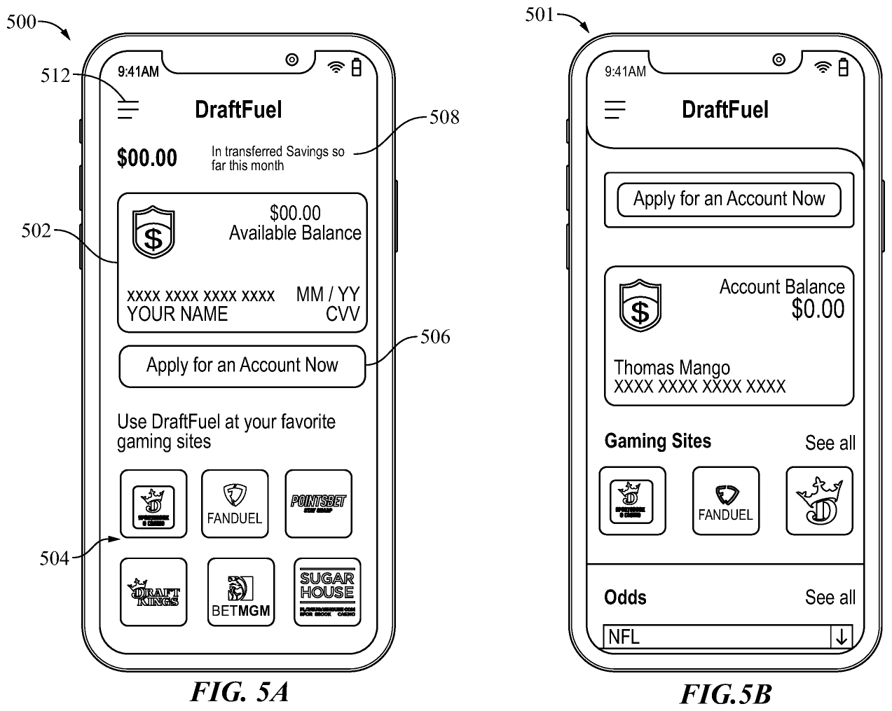

FIGS. 5A-5B illustrate an account signup user interface screen 500 and 501, respectively, according to some embodiments. As shown in the example embodiment, an example virtual debit card 502 can include an available balance, a virtual debit card number, a virtual debit card expiration date, a virtual debit card security code, a virtual debit card account holder name, and/or additional related information as appropriate. A gaming sites area 504 can include a series of icons that may be scrollable and selectable. An account signup button 506 can allow new users to apply for an account with the system when selected. A monthly transfer amount area 508 can include information about how much money has been transferred into the account over a given period (e.g. monthly, weekly, daily, or others). A selectable menu button 512 can display a menu in various embodiments.

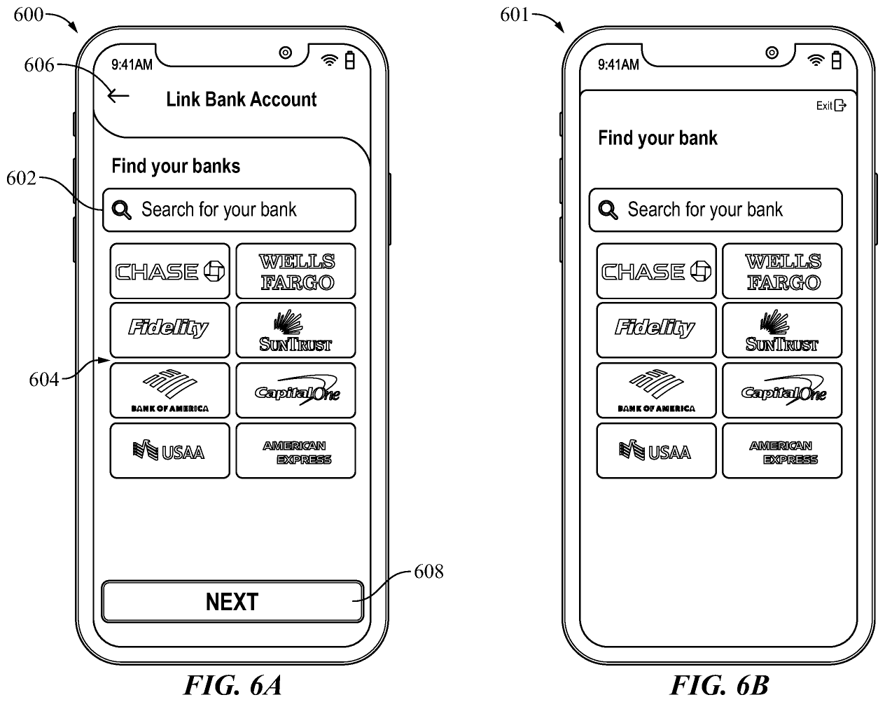

FIGS. 6A-6B illustrate a bank searching user interface screen 600 and 601, respectively, according to some embodiments. As shown in the example embodiment, a search field 602 can allow users to search for their bank through the system. In some embodiments the search field 602 may propose autofill bank names stored in computer memory as the user types characters into the search field 602. A selectable bank list 604 can include a series of icons that may be scrollable and selectable. A back button 606 can allow users to return to a previous or prior screen or go back to a home screen in various embodiments. A next button 608 allows a user to navigate to a next screen after they have entered their bank name in the search field 602 or selected a bank from bank list 604.

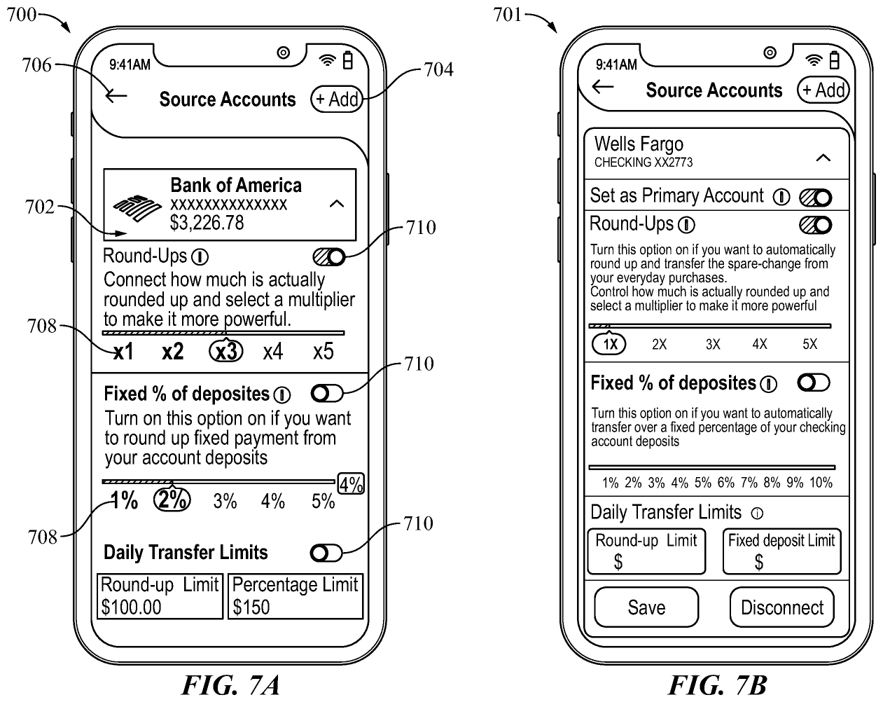

FIGS. 7A-7B illustrate an account financial management user interface screen 700 and 701, respectively, according to some embodiments. As shown in the example embodiment, a linked bank account section 702 can include account information such as a bank name, type of account (e.g. checking, savings, or others), account number(s), and others. Linked bank account section 702 can also include information and user selectable and/or editable buttons and/or fields. Information included can be Round-Ups (control how much is actually rounded up and select a multiplier to make it more powerful) at various levels (e.g. x1, x2, x3, x4, x5, or others). Information included can also be Fixed % of deposits (turn on this option if you want to round up fixed percent from your account deposits, i.e. an amount from a paycheck or other regular deposit) at various levels (e.g. %1, %2, %3, %4, %5, or others). Information included can also be Daily Transfer Limits (e.g. round up limit, percentage limit, and/or others). As shown, a user can use sliders 710 to turn particular features on and off. Sliders and/or radio buttons 708 can be included to allow users a great deal of customization. An add account button 704 can allow a user to link an account to their profile that will allow funds from the account to be used in the system. Button 704 may take a user to a bank searching user interface screen (e.g. see FIG. 6 and associated description) when selected by a user. A back button 706 can allow users to return to a previous or prior screen or go back to a home screen in various embodiments.

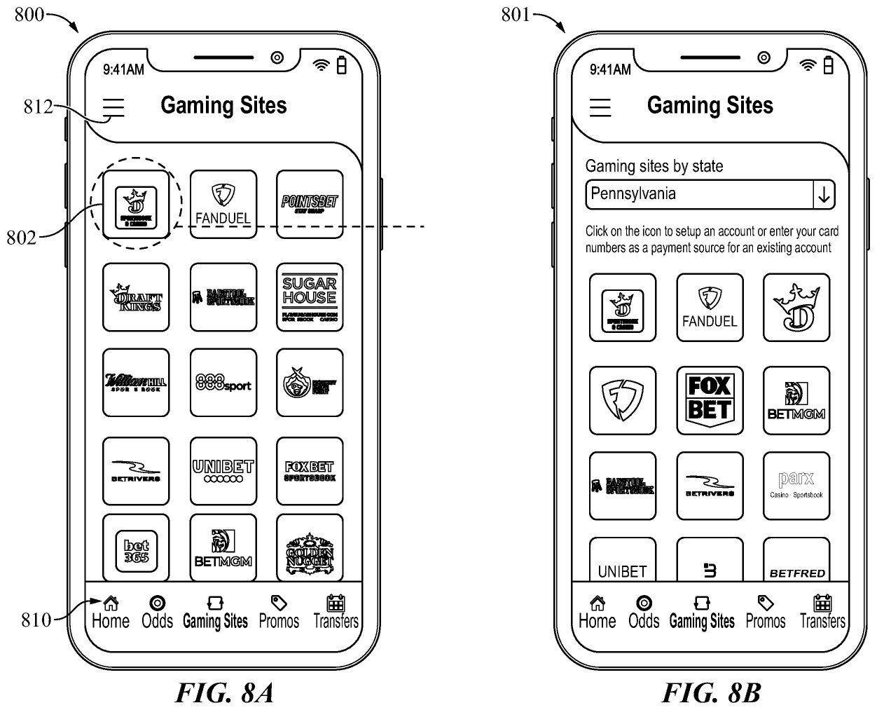

FIGS. 8A-8B illustrate a gaming sites election user interface screen 800 and 801, respectively, according to some embodiments. As shown in the example embodiment, a listing 802 of system connected gaming sites can include user selectable gaming sites. Navigation buttons 810 include a home button, an odds button, a gaming sites button, a promos button, a transfers button, or others in other embodiments. A selectable menu button 812 can display a menu in various embodiments.

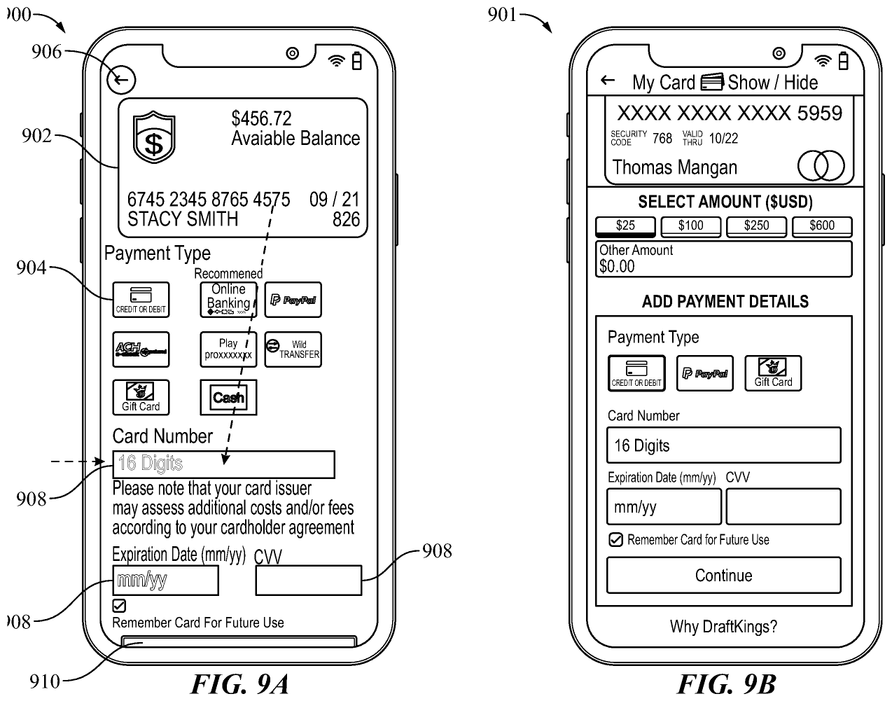

FIGS. 9A-9B illustrate a payment linking user interface screen 900 and 901, respectively, according to some embodiments. As shown in the example embodiment, a virtual debit card 902 can include an available balance, a virtual debit card number, a virtual debit card expiration date, a virtual debit card security code, a virtual debit card account holder name, and/or additional related information as appropriate. A payment type section 904 can include different user selectable buttons for payment types including one or more of credit or debit card, online banking, PayPal, ACH eCheck, Play+ prepaid card, wire transfer, gift card, cash, and/or others. A back button 906 can allow users to return to a previous or prior screen or go back to a home screen in various embodiments. Payment field(s) 908 can include card number, expiration date, CVV, and/or other fields that can allow a user to input the card number from their virtual debit card 902 or other cards in some embodiments. Users cards can be saved for future transactions for convenience. A confirm button 910 can allow the user to confirm their payment information. In some embodiments, information can be displayed in a web browser through the application and may be hosted or otherwise come from a third party web site, such as a gaming site. In some embodiments, the interface is displayed using an I-frame/web-browser separate from the application. Once displayed, the user may select a payment option such as one or more of credit or debit card, online banking, PayPal, ACH eCheck, Play+ prepaid card, wire transfer, gift card, cash, and/or others.

In some embodiments, if the user clicks on the sportsbook icons on the gaming sites screen or the promos screen it opens up this web-browser and takes the user to a specified page or the home page for the sportsbook's website. The card resides in a Show/Hide header at the top of the screen, above the browser. The user clicks to show the card and then Hide the card to remove it from the display.

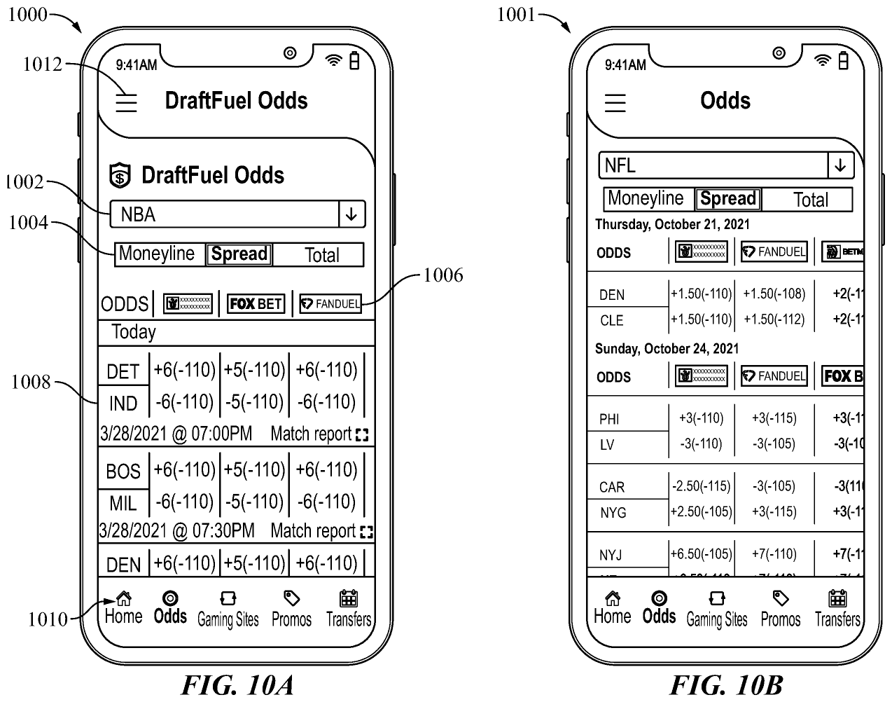

FIGS. 10A-10B illustrate an odds display user interface screen 1000 and 1001, respectively, according to some embodiments. A sport or league selection field 1002 can allow users to enter or select a sport and/or league (e.g. basketball, NBA, or others). An odds selection section 1004 can include selectable buttons including money line, spread, total, or others. Odds column headers 1006 can include information about which oddsmaker's odds are shown in the column below. Odds field 1008 can include odds, team information, scheduling information, and/or match report buttons. Navigation buttons 1010 include a home button, an odds button, a gaming sites button, a promos button, a transfers button, or others in other embodiments. A selectable menu button 1012 can display a menu in various embodiments.

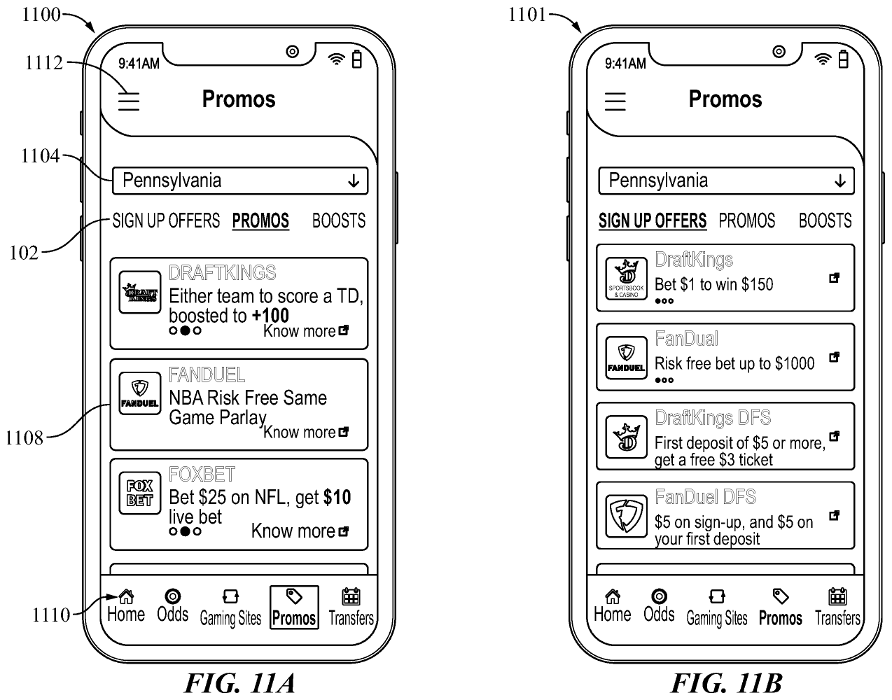

FIGS. 11A-11B illustrate an options selection user interface screen 1100 and 1001, respectively, according to some embodiments. Selectable buttons 1102 include sign up offers, promos, boosts, and others. A state or jurisdiction selection button 1104 can allow users to browse and select which location they want to place bets through. Promotions selections 1108 include promotions or deals that can be selected by users. Navigation buttons 1110 include a home button, an odds button, a gaming sites button, a promos button, a transfers button, or others in other embodiments. A selectable menu button 1112 can display a menu in various embodiments.

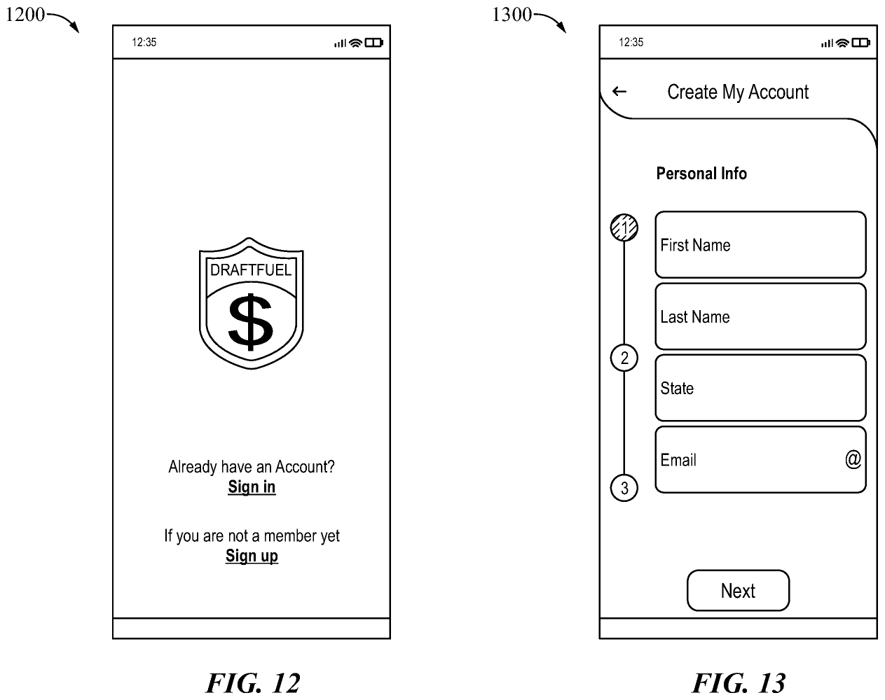

FIG. 12 illustrates a user sign up user interface screen 1200, according to some embodiments. As shown in the example embodiment, a user can select a sign in option if they have previously signed up for an account. If they are not a member yet, they can select a sign up button.

FIG. 13 illustrates an account creation user interface screen 1300, according to some embodiments. As shown in the example embodiment, users can enter information into various fields in order to create an account. These can include a first name, last name, location (e.g. state or locality), email address, and others. Once complete, they can select a next button.

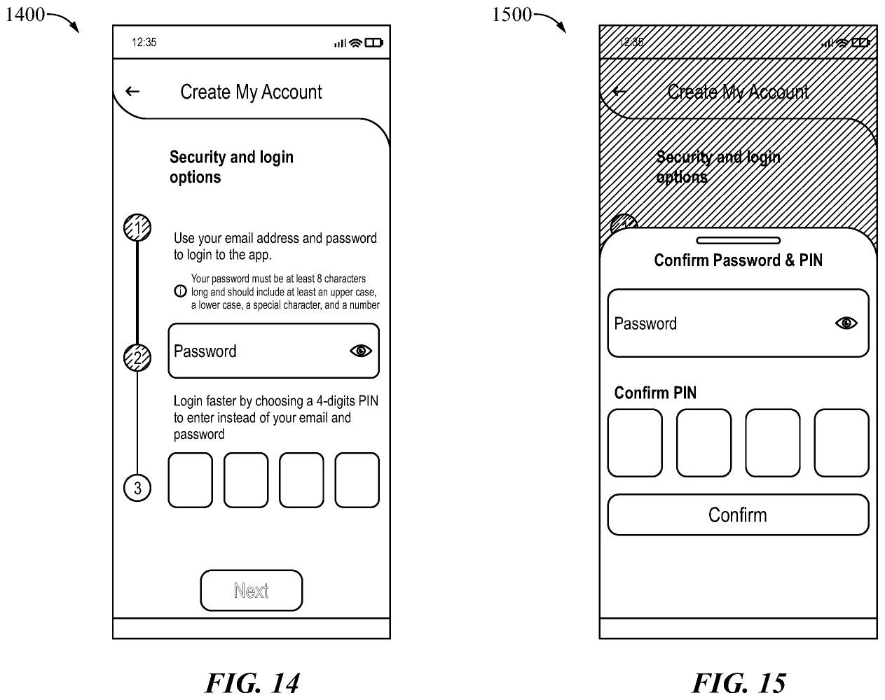

FIG. 14 illustrates a security and login options user interface screen 1400, according to some embodiments. As shown in the example embodiment, users can create a password and/or personal identification number (PIN) in order to provide security for their account.

FIG. 15 illustrates a confirm option and PIN user interface screen 1500, according to some embodiments. As shown in the example embodiment, users can enter the password and PIN a second time in order to confirm that they have been entered correctly. Thereafter, they may be required to enter one or both in order to access the system.

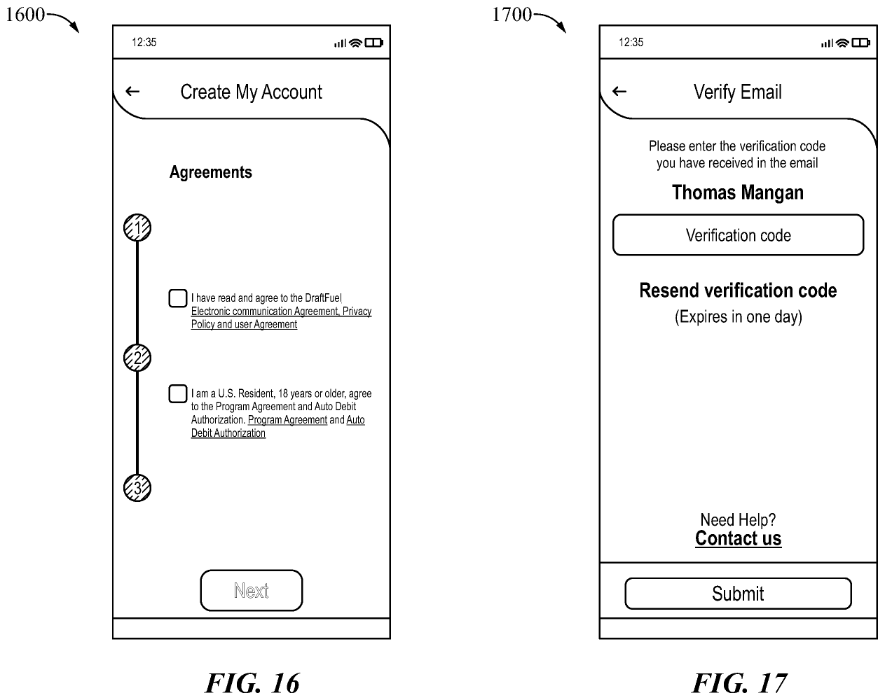

FIG. 16 illustrates an agreements user interface screen 1600, according to some embodiments. As shown in the example embodiment, users can select buttons that allow they to read and/or otherwise review system rules, regulations, and other information. They can then enter checks into boxes to indicate that they have reviewed the information.

FIG. 17 illustrates an email verification user interface screen 1700, according to some embodiments. As shown in the example embodiment, the system may send a confirmation email or notification to the user at a number, email address, social media account, or other location in order to prove that they have access to the account or are a real person. The system also includes a resend button if the user does not receive the code. Users can also contact the system's help if they have issues by selecting an appropriate help button.

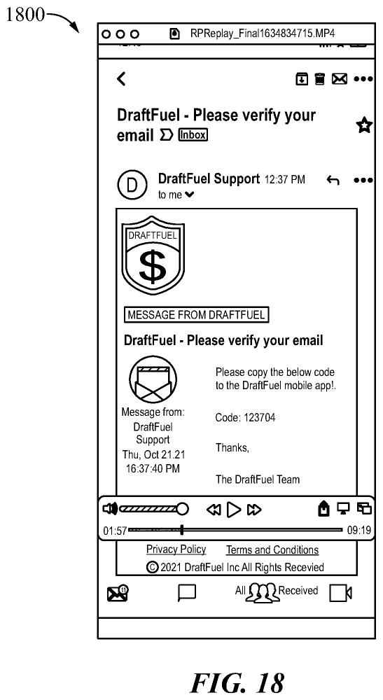

FIG. 18 illustrates an email user interface screen 1800, according to some embodiments. As shown in the example embodiment, a user may receive an email notification at the email address they entered in their account signup that includes a verification code that they need to enter in order for their account to be created. These emails may also be sent in the instance that users are trying to access the system, if they forget their password, or in others instances.

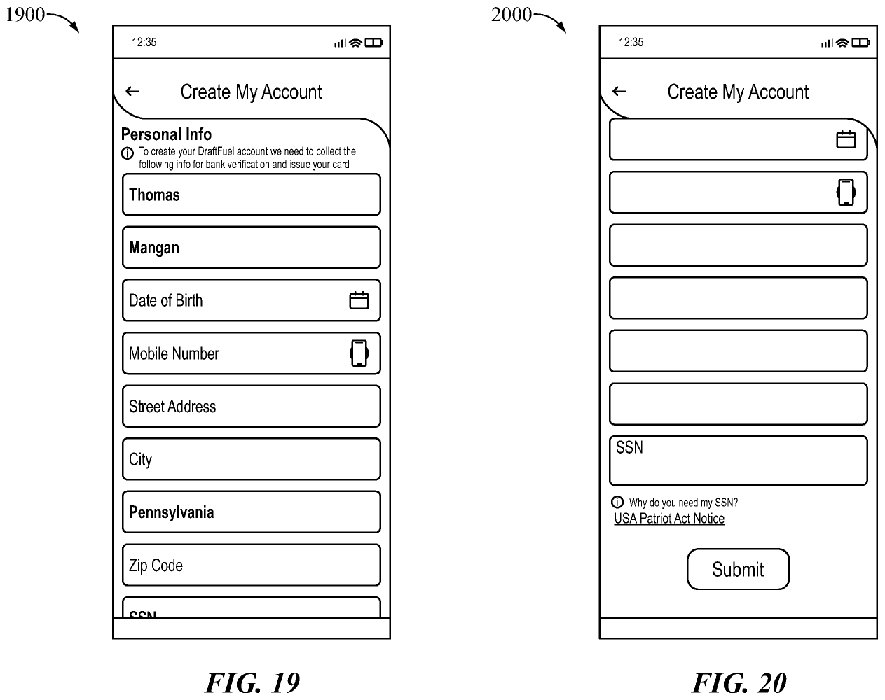

FIG. 19 illustrates an account personal information user interface screen 1900, according to some embodiments. As shown in the example embodiment, personal information can be entered in order to fill out a user account. This can include first and last name, date of birth, phone number, address, and others.

FIG. 20 illustrates an account personal information submission user interface screen 2000, according to some embodiments. As shown in the example embodiment, once the personal information has been entered the user can submit by selecting a submit button. Users may also review notice(s) from the system by selecting buttons.

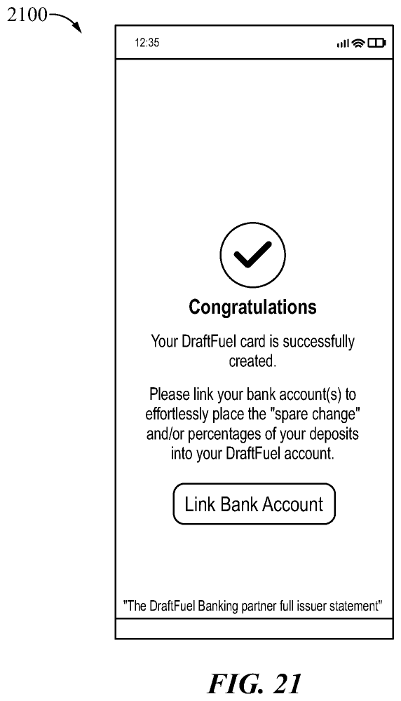

FIG. 21 illustrates an account personal information confirmation user interface screen 2100, according to some embodiments. As shown in the example embodiment, the system can display a confirmation button if the account creation process has been successful. Users can then select a button to link one or more bank accounts to the system in order to fund their betting.

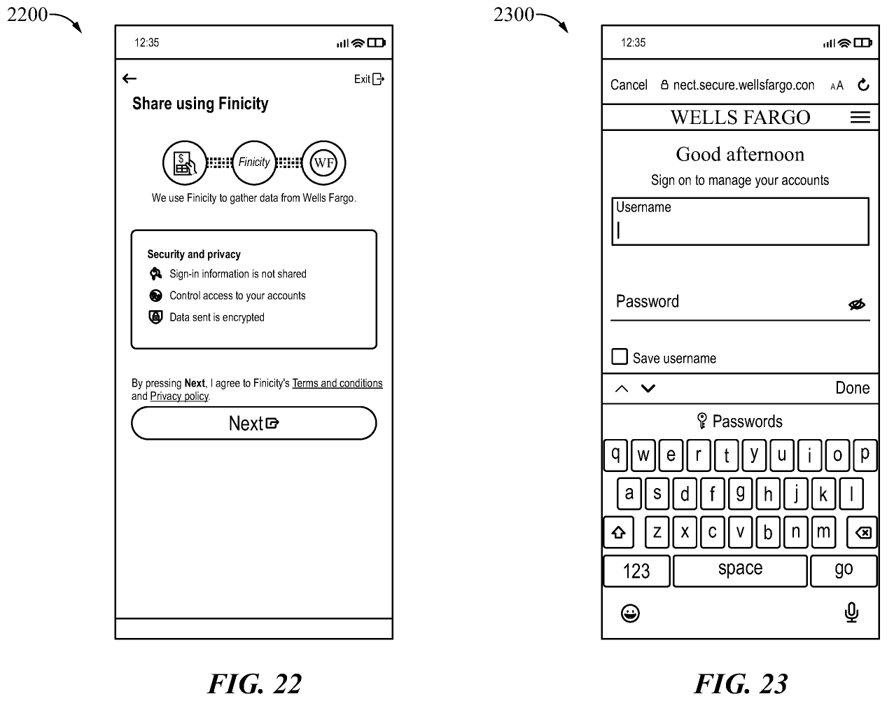

FIG. 22 illustrates an account linking user interface screen 2200, according to some embodiments. As shown in the example embodiment, users may have selected a bank that they hold an account at and then share the banking information with the system directly or through other banking or financial programs. The user may select next to confirm.

FIG. 23 illustrates an account sign in user interface screen 2300, according to some embodiments. As shown in the example embodiment, the system may access a user's selected banking platform directly or serve as a portal to the banking system. The user can enter a bank username and password as a step to linking their account.

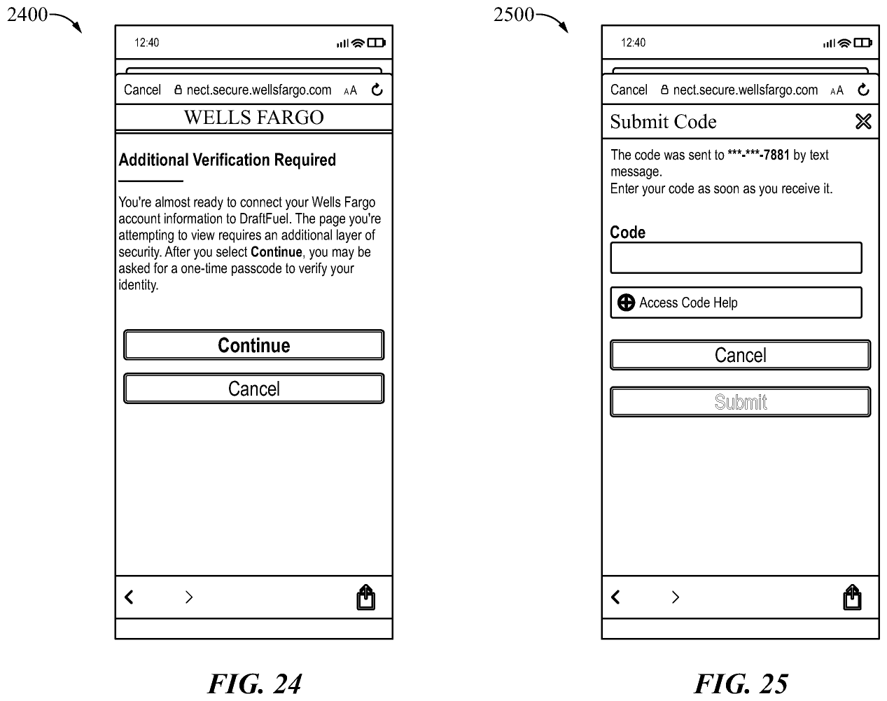

FIG. 24 illustrates an account verification requirement user interface screen 2400, according to some embodiments. As shown in the example embodiment, the banking platform may require additional verification in some instances. The user can elect to continue or cancel the linking operation by selecting the appropriate button.

FIG. 25 illustrates an account code entry interface screen 2500, according to some embodiments. As shown in the example embodiment, the banking platform may send a confirmation code to a user's email, phone, or other location that must be entered in order to log in or link the account to the system.

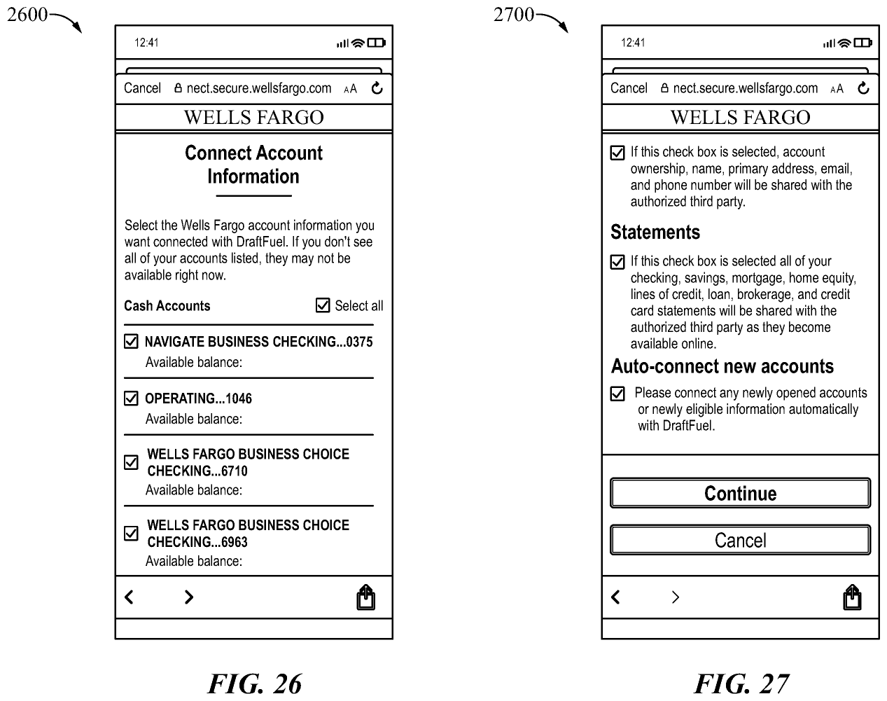

FIG. 26 illustrates an account selection user interface screen 2600, according to some embodiments. As shown in the example embodiment, the system may display one, some, or all accounts that a user has with a particular bank that they have logged into. They may select one or more accounts to grant access to the system in order to link their bet funding operations.

FIG. 27 illustrates an account sign in user interface screen 2700, according to some embodiments. As shown in the example embodiment, the user may review information and select one or more indicators that they have reviewed before selecting a continue button. The user may also cancel, if they desire.

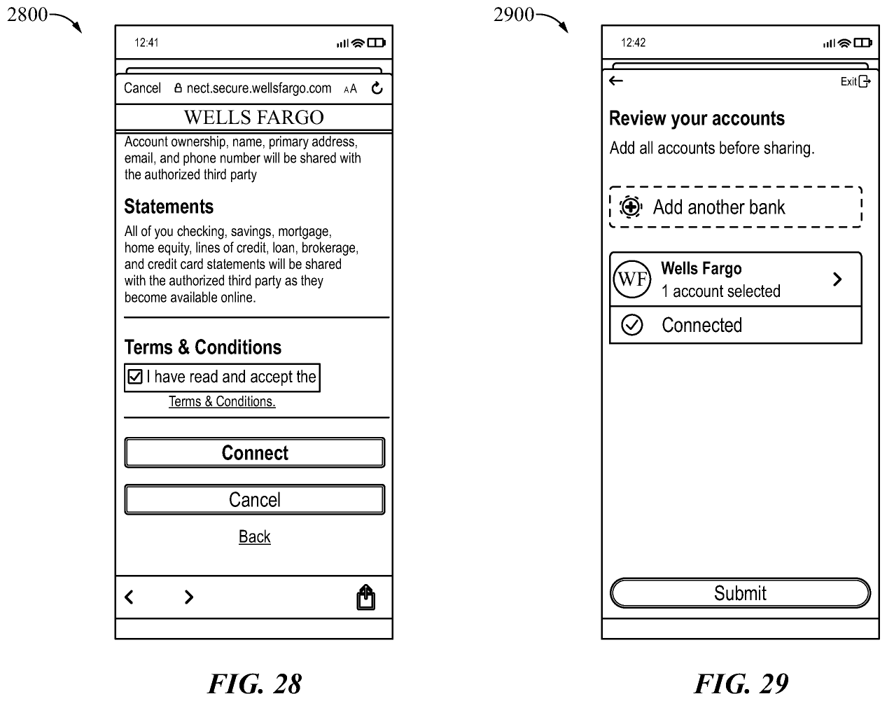

FIG. 28 illustrates an account information confirmation interface screen 2800, according to some embodiments. As shown in the example embodiment, the user can review terms and conditions by selecting an appropriate button. They can signal their review by selecting an indicator and may then connect their bank account to the system. Alternatively, they may choose to cancel the account linking operation or go back and change previous answers or decisions by selecting the appropriate button.

FIG. 29 illustrates an account terms and conditions user interface screen 2900, according to some embodiments. As shown in the example embodiment, users can add multiple banks in some instances and/or disconnect previously connected accounts. They can also select accounts they have linked in order to view account information.

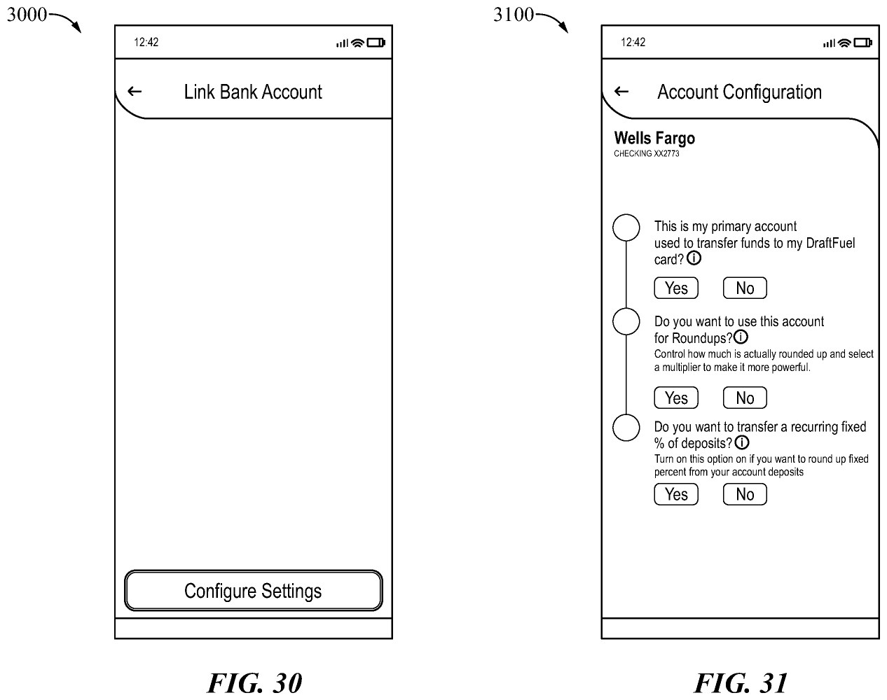

FIG. 30 illustrates an account link user interface screen 3000, according to some embodiments. As shown in the example embodiment, users can select a back button. Users can also select a setting configuration button.

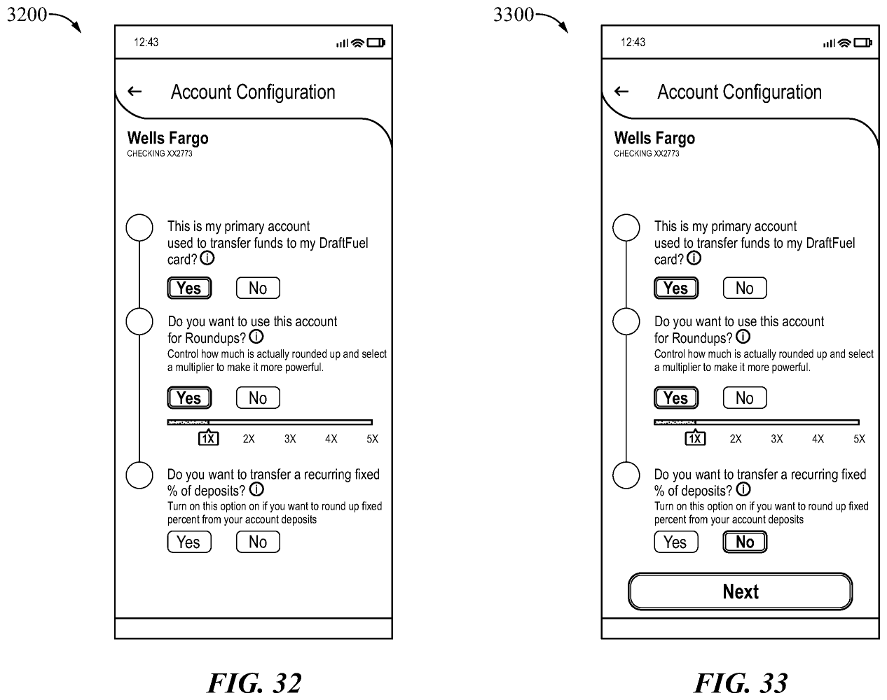

FIGS. 31-33 illustrate an account configuration user interface screen 3100, 3200, and 3300, respectively, according to some embodiments. As shown in the example embodiment, the user can choose different options such as whether to set an account as a primary system account, whether to use roundups for a particular account, whether to have a fixed percentage of income transferred to deposits with the system, or others.

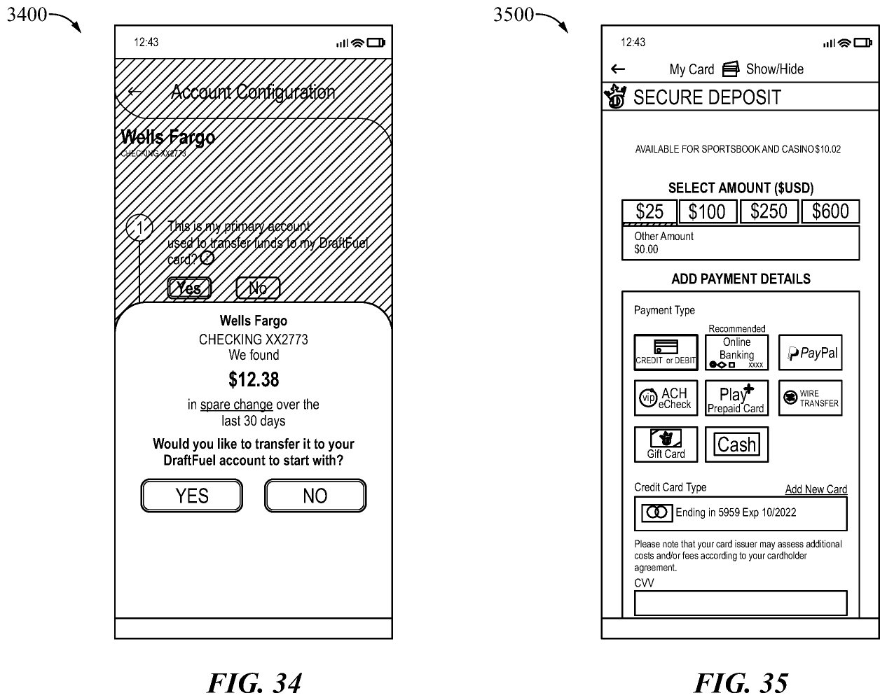

FIG. 34 illustrates an account funding user interface screen 3400, according to some embodiments. As shown in the example embodiment, the system can display how much funding from roundups and/or percentage transfers has occurred over a given period (e.g. days, weeks, months, or others). The user can then determine whether they want to use that amount to fund future betting operations.

FIG. 35 illustrates an existing account or creation user interface screen 3500, according to some embodiments. As shown in the example embodiment, the system can display how much the user can bet with. The user can then choose predetermined amounts to bet with or enter a custom amount in a field. They can also choose one or more payment options (e.g. credit or debit, online banking, PayPal, ACH, Play, wire transfer, gift card, cash, or others). They can also enter card information into appropriate fields. The account creation user interface 3500 allows for the user to create an account with a sportsbook via their website or to enter their payment information (e.g., debit card, account number, routing number, etc.) as a source of payment.

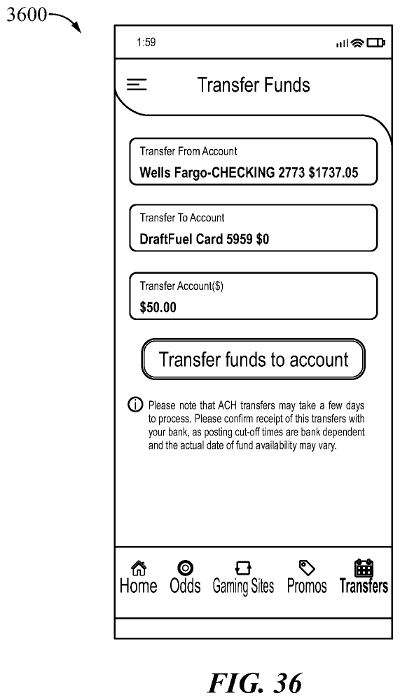

FIG. 36 illustrates an existing account or creation user interface screen 3600, according to some embodiments. As shown in the example embodiment, users can transfer funds from their linked account(s) to the system by selecting a transfer button, selecting the linked account, choosing an account to receive the funds, and choosing and/or entering the amount to be transferred. The user may also transfer money from their account to their linked bank account.

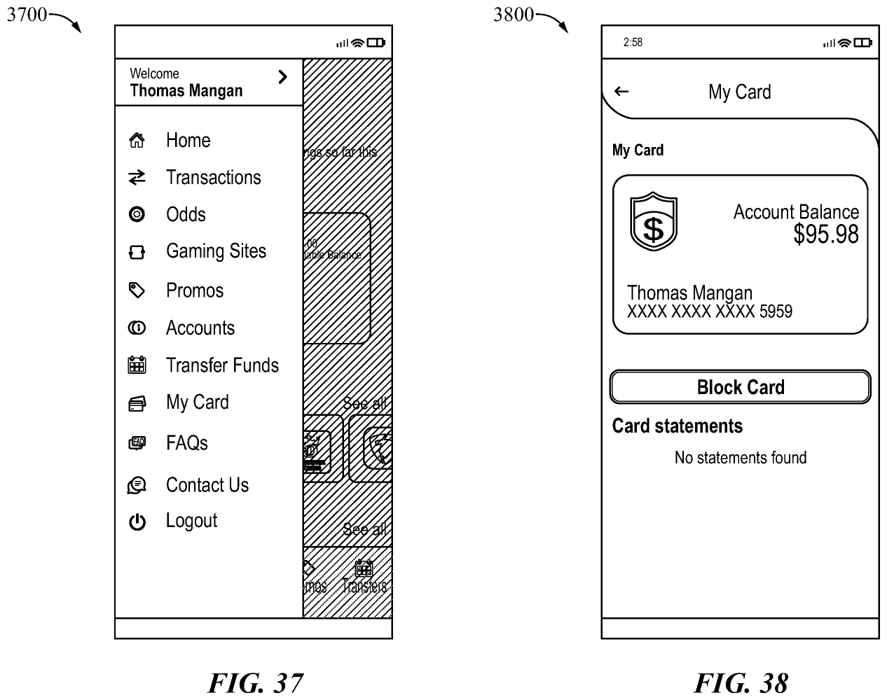

FIG. 37 illustrates a menu user interface screen, according to some embodiments 3700. As shown in the example embodiment, menu options can include a variety of buttons. These can include home, transactions, odds, gaming sites, promos, accounts, transfer funds, my card, FAQs, contact us, logout, or others. Selecting a button can cause the system to display the appropriate screen.

FIG. 38 illustrates a fund information user interface screen 3800. according to some embodiments. As shown in the example embodiment, users can view an account balance, block a card, view statements, or other functions by selecting an appropriate button.

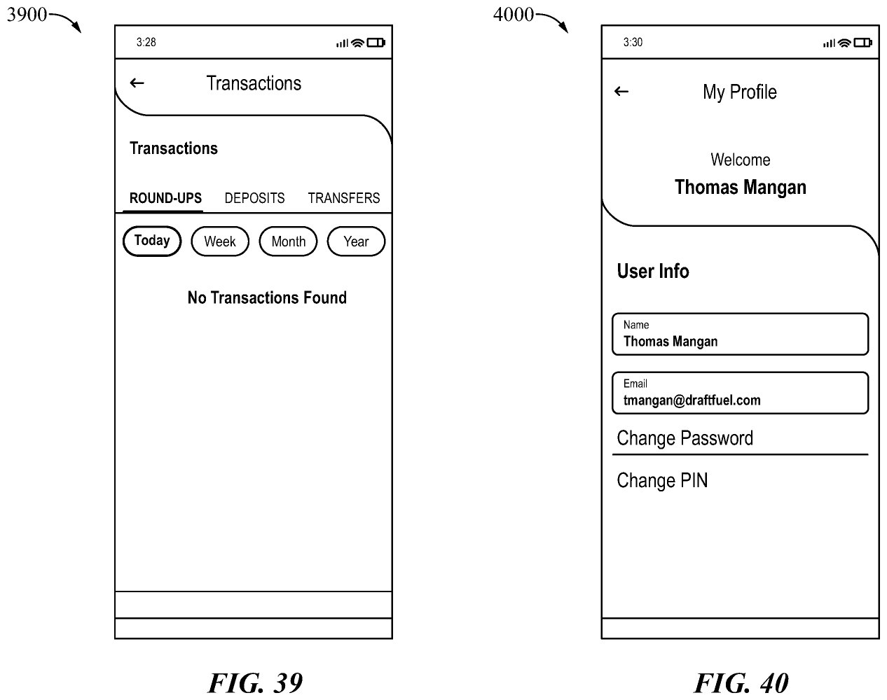

FIG. 39 illustrates a transactions user interface screen 3900, according to some embodiments. As shown in the example embodiment, users can view transactions with the system by selecting one of a variety of tabs. These can include round ups, deposits, transfers, and others. The transactions can further be refined for display by selecting a time period (e.g. day, week, month, year, or others).

FIG. 40 illustrates a user info user interface screen 4000, according to some embodiments. As shown in the example embodiment, the users name, contact information (email, phone number, or others) and other information can be displayed and/or edited. Users can also elect to change their password and/or pin by selecting an appropriate button.

As described herein, in various embodiments, the user has the ability to select a fixed percentage of their external bank account deposits to move over to their system account, in addition to or as an alternative of the spare change round-ups.

In various embodiments, the funds are not moved to the system application. In many embodiments, the user is setting up a pre-paid debit card account through the system application with a system banking partner. The application can then be used to facilitate the transferring of money in and out of the account as well as to display the virtual debit card and/or account and routing number information of the user's account.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A sports betting system, comprising:
a sportsbook database in operable communication with a user interface module, the sportsbook database to store sports betting information to be provided on the display of a user device;
a financial database in operable communication with a financial institution and user account thereof, the financial database to store a plurality of funds to be accessed while the user places a sports bet;
a financial monitoring engine to monitor a plurality of transactions associated with the user account, wherein the financial monitoring engine rounds up each transaction until a threshold value is reached; and
a fund transfer engine to transfer the threshold value to the application system to permit the user to utilize the threshold value to place the sports bet.

2. The system of claim 1, further comprising a user database to store user preferences, user sports betting history, and at least one preferred threshold value associated with the user.

3. The system of claim 1, further comprising a financial database to store financial information associated with the user.

4. The system of claim 1, wherein the sportsbook database stores a plurality of information corresponding to a plurality of sporting events.

5. The system of claim 4, wherein the sportsbook database stores a plurality of information related to one or more participants of a sporting event.

6. The system of claim 1, wherein the user selects a threshold value to initiate a fund transfer via the fund transfer engine.
